(19) United States
(12) Patent Application Publication
(10) Pub. No.: US 2010/0065532 A1
(43) Pub. Date: Mar. 18, 2010

(54) SEALED AND PRESSURIZED GUN FOR UNDERWATER WELDING

(76) Inventor: Clark Champney, Vermillion, OH (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/537,481

(22) Filed: Aug. 7, 2009

Related U.S. Application Data
(60) Provisional application No. 61/086,907, filed on Aug. 7, 2008.

(51) Int. Cl. B23K 37/00; B23K 9/20

(52) U.S. Cl. 219/74; 219/98

(57) ABSTRACT

An underwater fastener welding apparatus that includes a welding tool positioned within a watertight housing. The housing includes an inlet coupled to a source of pressurized gas. The housing is pressurized to balance a pressure internal to and external to the housing when the underwater welding apparatus depth level is changed.

### CROSS-REFERENCE TO RELATED APPLICATIONS

This application claims priority benefit of U.S. provisional patent application No. 61/086,907 filed on Aug. 7, 2008 and is herein incorporated by reference.

### FIELD OF THE INVENTION

The invention relates to underwater stud welding guns and underwater assemblies for stud welding guns.

### BACKGROUND OF THE INVENTION

Underwater welding may be performed to attach or connect various components. There is a need in the art for an improved stud welding gun that will function normally in an underwater environment.

The external pressure that is exerted on any submerged object varies with the depth of the water. In fresh water the pressure is 0.432 psi per foot of depth. In salt water the pressure is 0.445 psi per foot of depth. The depth of the water and the compressible area of the gun that that is exposed to the water will determine the total force that will be applied against a spring inside the gun that actuates a stud or component in a lift and plunge cycle. The pressure of the water pushing against the spring in the gun may obstruct or even prevent the stud from being pushed into the weld metal at the end of the weld cycle.

There is therefore a need in the art for a stud welding gun and apparatus that may be sealed in a watertight capsule that can be pressurized to same internal pressure as the water pressure outside the gun for stud welding underwater. Pressurizing the gun with a gas to balance the pressure inside the gun with the pressure that is applied to the outside of the gun by the water will allow the gun to function in a similar manner to that of a gun used in a non underwater environment.

There is also a need in the art for sealing and pressurizing a gun interior to balance with the water pressure outside as the volume of the gun must change during the Lifting and Plunging portions of the stud welding cycle of the stud welding process. The spring inside the gun exerts a fixed pressure and as the gun is taken to deeper depths of water the pressure of the water may be greater than the spring inside the gun and the gun will no longer function.

There is also a need in the art for a welding gun encapsulated in a dry sealed chamber as it can be lubricated art to protect the mechanical parts and provide consistent lift and plunge motions that are needed for stud welding.

### SUMMARY OF THE INVENTION

In one aspect there is disclosed an underwater fastener welding apparatus that includes a welding tool positioned within a watertight housing. The housing includes an inlet coupled to a source of pressurized gas. The housing is pressurized to balance a pressure internal to and external to the housing when the underwater welding apparatus depth level is changed.

In another aspect there is disclosed an underwater fastener welding apparatus that includes a welding tool positioned within a watertight housing. The housing includes an inlet coupled to a source of pressurized gas. The housing is pressurized to balance a pressure internal to and external to the housing wherein a weld is performed in a wet environment.

### BRIEF DESCRIPTION OF THE DRAWINGS

FIG. 1 is a perspective view of one embodiment of an underwater welding apparatus;

FIG. 2 is a perspective view of one embodiment of an underwater welding apparatus;

FIG. 3 is a perspective view of a second embodiment of an underwater welding apparatus;

FIG. 3A is a photographic view of the second embodiment including a chuck, stud and ferrule;

FIG. 3B is an exploded perspective view of a second embodiment of an underwater welding apparatus;

FIG. 4 is a perspective view of a second embodiment of an underwater welding apparatus;

FIG. 5 is a sectional view of a second embodiment of an underwater welding apparatus;

FIG. 6 is a front and side view of a welding tool that may be utilized in the underwater welding apparatus of the first and second embodiments;

### DETAILED DESCRIPTION OF THE PREFERRED EMBODIMENTS

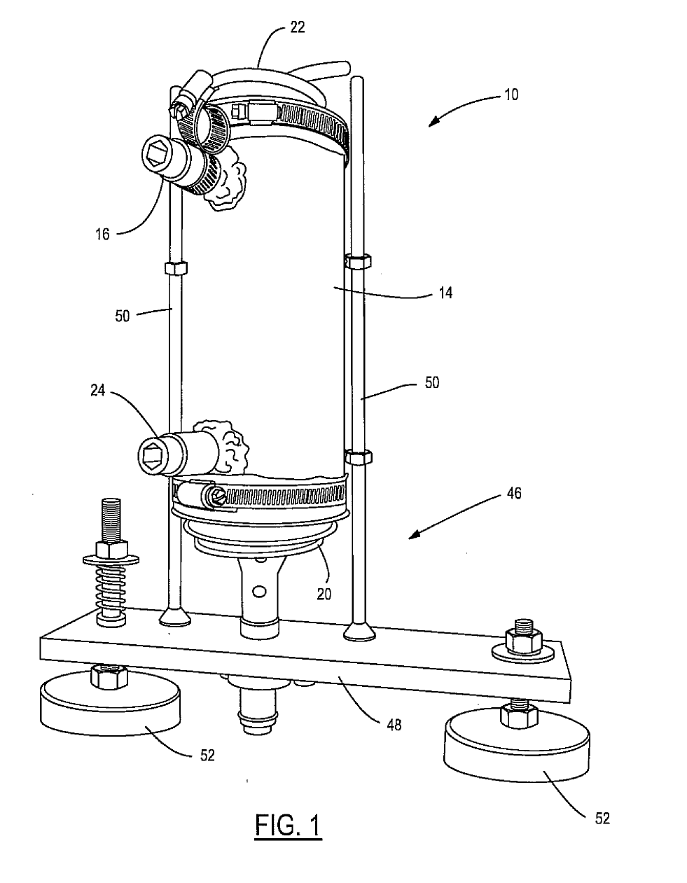

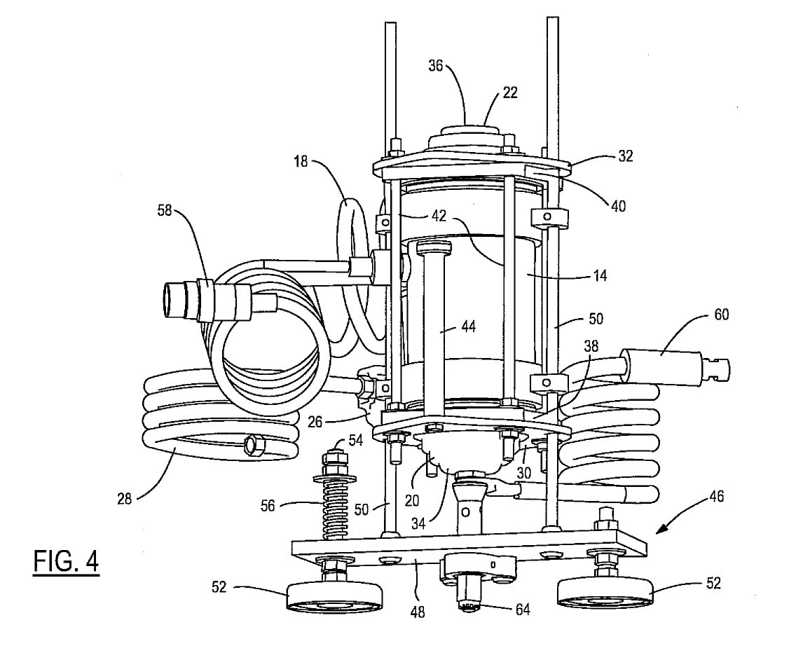

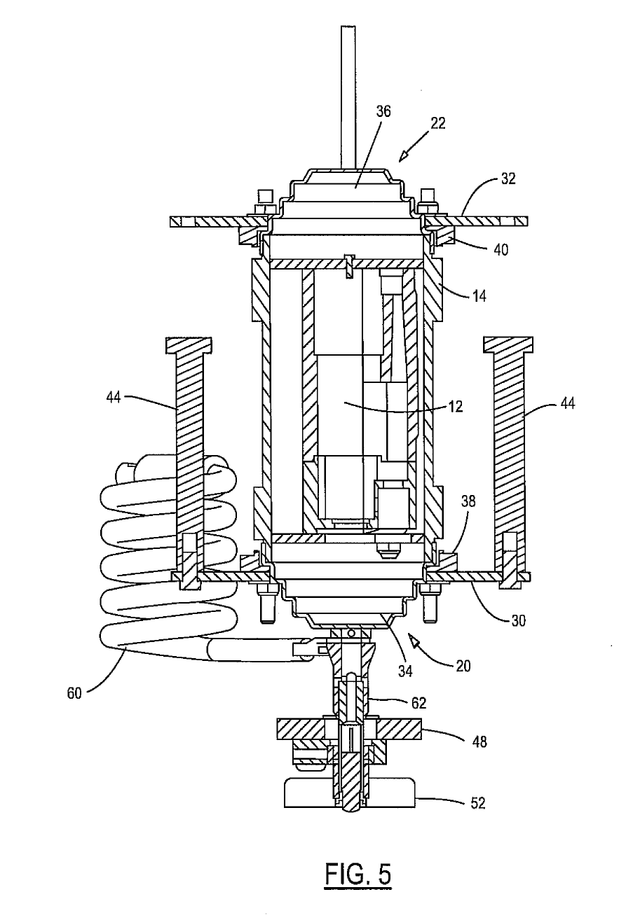

A fastener welding process and apparatus may include both drawn arc and capacitor discharge (CD) welding processes and apparatus. Referring to FIGS. 1 through 5 there is shown various embodiments of an underwater welding apparatus 10. The underwater welding apparatus 10 may include a welding tool 12 positioned within a water tight housing 14. The housing 14 may include an inlet 16 that is coupled to a source of pressurized gas 18 that may be connected to a regulator 26. The housing 14 may be pressurized by the regulator 26 to balance a pressure internal to and external to the housing 14 when the underwater welding apparatus 10 depth level is changed.

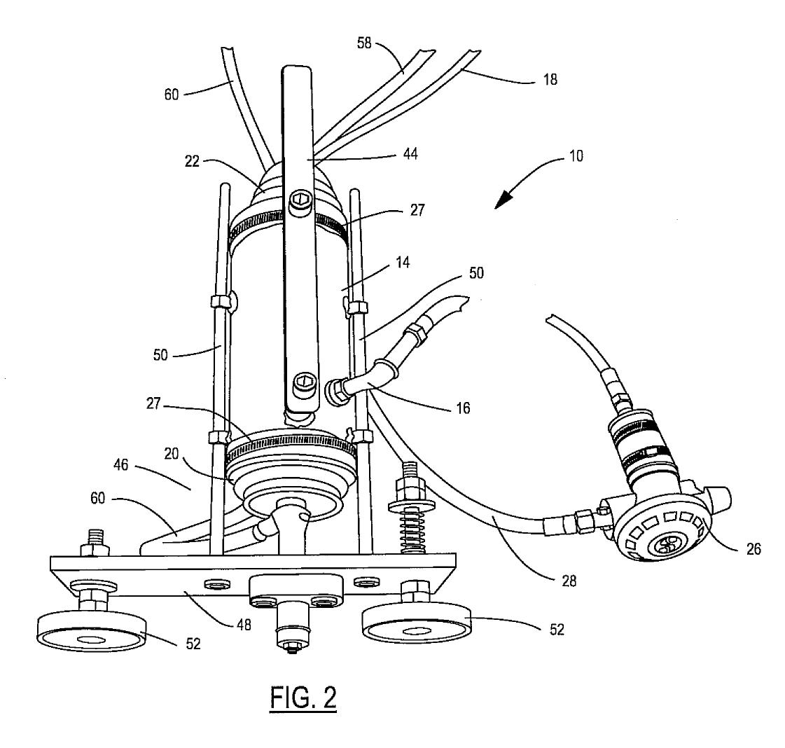

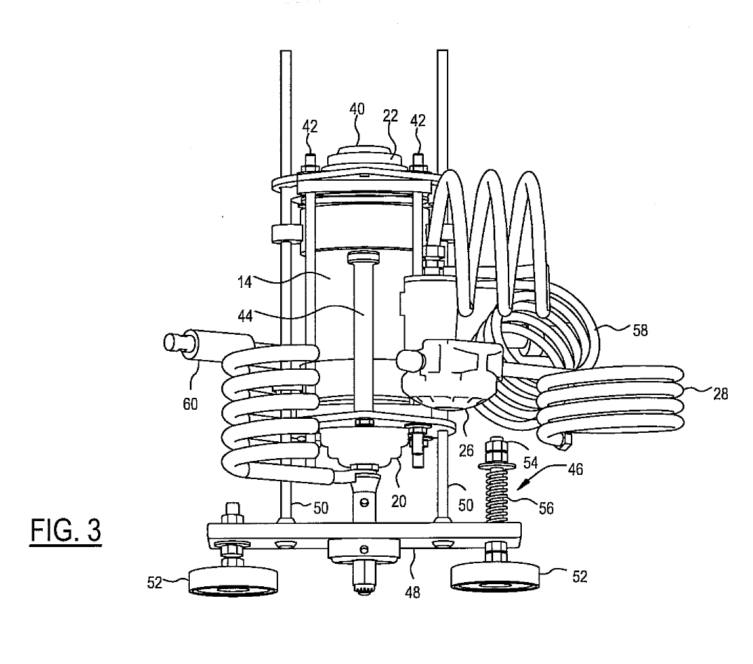

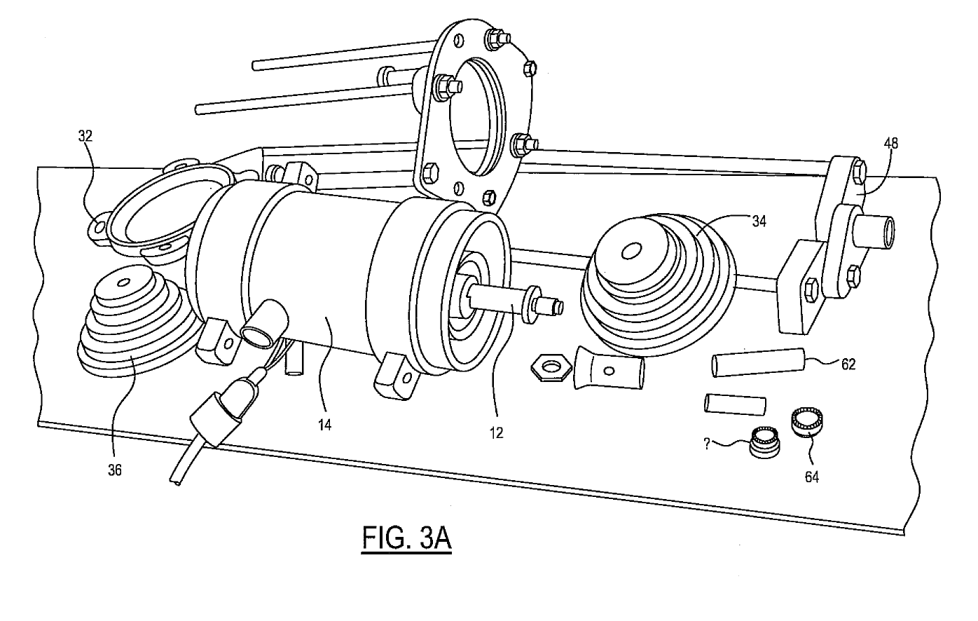

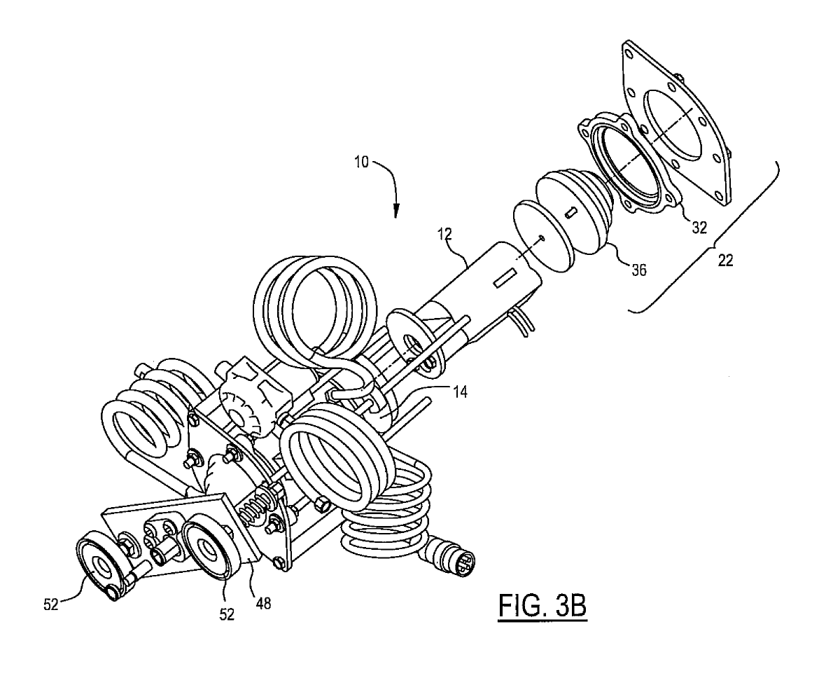

The first embodiment shown in FIGS. 1 and 2 and the second embodiment shown in FIGS. 3 through 5 differ in the structure and type of housing 14 utilized. In the first embodiment of FIGS. 1 and 2, the housing 14 may include a metal tube having open ends. The housing 14 of the first embodiment may include flexible front and rear seal assemblies 20, 22 attached to the open ends of housing 14. The front seal assembly 20 may include a flexible rubber boot or similar structure that allows for back and forth movement of the welding tool 12 during a welding operation. Additionally, the housing may include a pressure relief device 24 that is connected to the housing 14. Various pressure relief devices 24 including valves and constant bleed orifices may be utilized. The front and rear seal assemblies 20, 22 of the first embodiment may be attached to the housing 14 utilizing hose clamps or similar devices 27. The welding tool 12 may be positioned within the housing 14 and may be attached in the housing 14 in any suitable manner.

The second embodiment depicted in FIGS. 3, 4 and 5 may include a housing 14 that is formed of a plastic such as PVC or the like and includes open ends. As with the first embodiment described above, the housing 14 may include a front seal assembly 20 attached to the housing 14 allowing sealed movement of the welding tool 12. A rear seal assembly 22 may be attached to the housing to allow access to the inside of the housing 14. Additionally, a standard welding tool 12 may be mounted within the housing and will be discussed in more detail below. The front and rear seal assemblies of the second embodiment differ from those described above with respect to the first embodiment and again will be described in more detail below.

In both of the embodiments described above, a gas regulator 26 may be coupled to the housing 14 and linked with the source of pressurized gas 18. The regulator 26 adjusts the amount of pressurized gas flowing to the internal space of the housing 14 to maintain a balance of pressure on the inside and exterior of the housing 14 as the underwater welding apparatus 10 depth level is changed.

In one aspect, the watertight housing 14 includes an internal volume that is greater than the volume of the welding tool 12. The volume may be of a size such that changes in the volume within the housing 14 due to actuation of the welding tool 12 have a negligible effect on the motion of the welding tool 12. For example, as the welding tool is actuated, a piston and other portions of the welding tool 12, such as a chuck or a portion of a part to be welded may enter and exit the housing 14 through the front seal assembly 20 thereby changing the overall air volume within the housing 14. The housing 14 should have a volume that is sufficiently large, such that changes in the volume due to the actuation of the welding tool 12 may be absorbed by the greater volume of gas within the housing 14, such that the motion of the welding tool 12 will not be affected. Additionally, a hose 28 may be coupled to the inlet 16 and the source of pressurized gas 18. The volume within the hose 28 may also provide an additional interior volume of gas to absorb the volumetric changes associated with actuation of the welding tool 12.

Referring to FIGS. 3 through 5, the second embodiment of the underwater welding apparatus 10 as outlined above, may include a front seal assembly 20 attached to the housing allowing sealed movement of the welding tool 12 during a welding operation. The rear seal assembly 22, as described above, may be attached to the housing 14 and allows for access to the inside of the housing 14 to allow for servicing and adjustment of the welding tool 12. In one aspect, the front and rear seal assemblies 20, 22 may include seal plates 30, 32 positioned above the open ends of the housing 14. The seal plates 30, 32 may receive seals 34, 36 that are positioned in seal seats 38, 40 formed on the housing 14. The front and rear seal plates 30, 32 may be joined by tie rods 42 that tighten to seal the front and rear seal assemblies 20, 22 relative to the housing 14.

The underwater welding apparatus 10 may also include handles 44 that are attached to the housing 14 to allow for manipulation of the underwater welding apparatus 10 by an operator or diver.

Both the first embodiment shown in FIGS. 1 and 2 as well as the second embodiment shown in FIGS. 3 through 5 may include a foot assembly 46 that may be attached to the housing 14. The foot assembly 46 may include a foot plate 48 attached to legs 50. The legs 50 may be adjustably attached to the housing 14 allowing for positioning of the foot assembly 46 relative to the housing 14 and the part to be welded, such as a stud. In one aspect, the foot assembly 46 includes magnets 52 mounted thereon. The magnets 52 may be attached to a metal work piece such that an operator or diver does not need to hold or apply pressure to the underwater welding apparatus 10 during a welding operation. The holding force of the magnets 52 is in one aspect, greater than a spring pressure of the welding tool 12. In one aspect, at least one of the magnets 52 is fixed relative to the foot plate 48 and another magnet 52 is adjustable relative to the foot plate 48. The adjustable magnet 52 may be attached to a shaft 54 that is biased by a spring 56 relative to the foot plate 48 to accommodate welding surfaces that may not be level. In this manner, the fixed magnet 52 may be attached to a portion of the metal work piece and the adjustable magnet 52 may be attached and accommodate various angles of the work piece.

Again referring to FIGS. 2 through 5, the underwater welding apparatus 10 may include a welding tool lead 58 that penetrates the housing 14 and is sealed relative to the housing 14. The weld tool lead 58 may be coupled to the welding tool 12 to supply power to a lift and plunge solenoid of the welding tool 12. The welding lead may also provide control signals to the welding tool 12. Additionally, a welding cable 60 may be attached to the welding tool 15 to provide a weld power for a welding operation.

The underwater welding apparatus 10 may also include a chuck assembly 62 that is attached to the welding tool 12. The chuck assembly 62 may be designed to hold a part to be welded such as a threaded or headed stud or other welding component such as an internally tapped stud, weld nut or angled part. In one aspect, a ferrule 64 may be attached to the weld tool 12 about the part to be welded. The ferrule 64 may be held by a ferrule grip or mounted on the foot assembly 46. In one aspect, the ferrule 64 may be formed of a ceramic that includes a waterproof coating applied thereon. The waterproof coating prevents entry of water into the ferrule 64 around the part to be welded during the welding operation. In one aspect, and as stated above, the welding operation is performed in a wet environment, or in other words the part to be welded is not surrounded by a dry environment such as an air bubble or other structure.

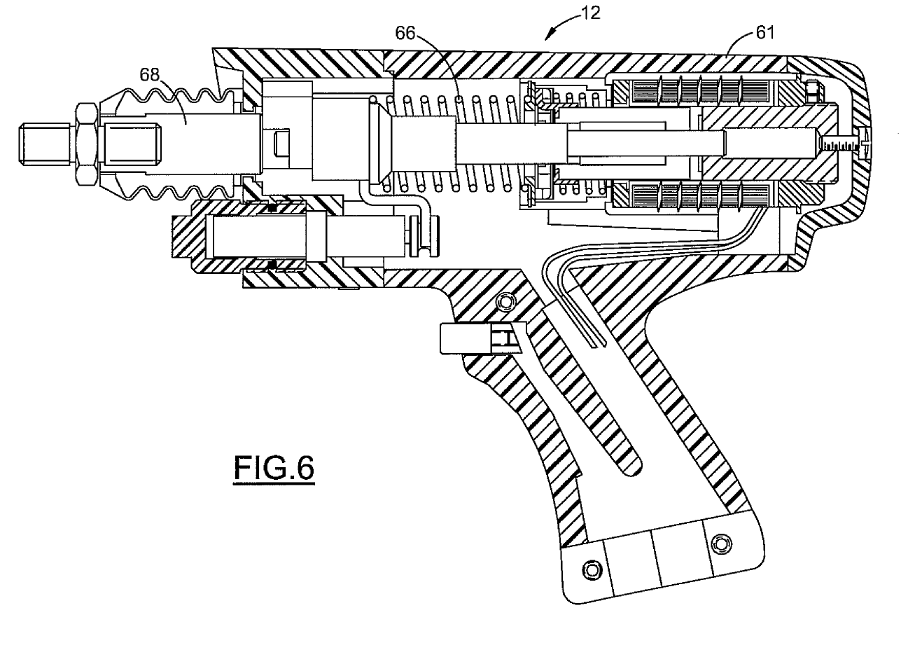

Referring to FIG. 6, there is shown one embodiment of a welding tool 12 that may be utilized in the underwater welding apparatus 10. As can be seen in the Figure, the welding tool 12 may be a heavy duty stud welding gun as is known in the art. The housing 61 of the welding gun shown in the figure may be removed to attach to the housing 14 of the underwater welding apparatus 10. The welding tool may include a spring 66 actuated piston 68 for lifting and plunging a part to be welded into a molten pool of a work piece formed during the welding operation.

In use, a part to be welded such as a stud may be inserted into a chuck assembly 62 at the front of the welding apparatus 10. The welding apparatus 10 may be positioned relative to the base material such that the foot and ceramic ferrule 64 that is attached to the welding tool 12 contacts the base material. This motion forces the stud or part to be welded back into the welding tool 12 and it compresses the spring 66 of the welding tool 12. The source of pressurized air 18 and regulator 26 provides gas to an interior of the housing 14 such that as the depth of the welding apparatus 10 is changed the pressure on the inside of the housing 14 is equal to or balanced with an exterior of the housing 14. The equalized pressure maintained within the housing allows for the lift and plunge operation as described above to proceed without interference due to pressure exerted on an exterior of the mechanism on the flexible forward seal 20 and rear seal 22 of the underwater welding apparatus 10. For example, pressure is exerted on any submerged object and may vary with the depth of the object. For example, pressure exerted in fresh water is 0.432 psi per foot of depth. In salt water, the pressure may vary at 0.445 psi per foot of depth. The depth of water in the compression area of the front seal 20 and rear seal 22 that are exposed to the water will determine a force that is applied against the spring 66 of the welding tool 12. Should the underwater welding apparatus 10 be submerged to a depth where a force exceeds that of the spring 66, then the plunge and lift mechanism will not operate correctly. This problem is solved by the equalization of the air pressure through the use of the regulator 26 and pressurized source of gas 18 such that the pressure on the interior and the exterior of the housing is equalized.

Additionally, as the housing 14 is sealed against the entry of water, the welding tool 12 is not exposed to a corrosive environment such as sea water and is not affected by the volume of water or the type of water allowed entry into a housing and contacting a welding tool such as in prior art applications. Additionally, a dry sealed environment also provides for lubrication and protection of the mechanical parts of the welding tool 12 to provide a consistent lift and plunge motion of a part to be welded.

Various gasses may be introduced into the housing 14 such as air, carbon dioxide, nitrogen or other inert gasses to equalize the pressure on the interior and the exterior of the housing 14.

### EXAMPLES

A Nelson™ Heavy Duty Gun, as shown in FIG. 6 was encapsulated in a housing. A seal formed of a suitable material such as rubber and having a boot or bellows was used to seal opposing ends of the housing. An inlet in the housing provided entry of a source of pressurized gas and was attached to a scuba regulator (a Scuba Pro II Stage G250HP in the S600/600P version). The regulator was attached to the housing a high pressure line to which was provided high pressure air supplied at 150 psi from a tank or compressor. The regulator increased the pressure inside the gun to match the pressure as the depth was increased. The pressurization of the gun allowed the lift and plunge to take place normally and was not affected by a depth of the underwater stud welding gun. From the example described above, the depth of the tank that the testing was conducted was at 18 feet of depth.

The foot assembly was attached to the housing and applied to a work piece that was positioned at 18 feet of depth. Magnets mounted on the foot assembly provided sufficient holding force during the test such that the apparatus was attached to the base metal securely such that the gun and regulator and base material could be lowered to the desired depth in the test tank and then the weld was performed. A series of welds were made and each weld was of a quality consistent with a normal welding operation.

When a weld was made in the water, a bubble of hydrogen and oxygen was formed and rose to the surface. After each weld, as the pressurized gun was removed to surface, a decrease of pressure and expansion of the air in the gun occurred resulting in an escape of air from the exhaling valve of the scuba regulator. This indicated a balancing of the gas pressure within the housing equal to the reduced external pressure.

The weld quality was consistent throughout the testing procedure and welds had normal burn off for reduction in length. For example, using lower than normal settings for a welding operation with a time of 0.5 seconds and a current of 650 amps with a lift of 1/16th of an inch and plunge of ¼ of an inch the after weld length was nearly 3/16 of an inch less than before the weld length indicating a quality weld.

Additionally, ceramic ferrules as described above were waterproofed and utilized in the testing procedure. The waterproofing of the ceramic ferrules included soaking of the ferrules in a liquid wax, oil, varnish, shellac, plastic, polyurethane, or other waterproofing material. During the waterproofing treatment the waterproofing agent was heated and the ferrules were allowed to soak in the heated liquid for a sufficient time so that the majority of air trapped in the porous ceramic would expand and be replaced by the liquefied waterproofing medium. In one aspect, the ceramic ferrules may be color coated to identify a waterproofed ferrule to provide easy identification.

1. An underwater fastener welding apparatus comprising:
a welding tool positioned within a watertight housing, the housing including an inlet coupled to a source of pressurized gas;
wherein the housing is pressurized to balance a pressure internal to and external to the housing when the underwater welding apparatus depth level is changed.

2. The underwater fastener welding apparatus of claim 1 including a gas regulator coupled to the housing and linked with the source of pressurized gas.

3. The underwater fastener welding apparatus of claim 1 wherein the watertight housing includes an internal volume greater than the volume of the welding tool.

4. The underwater fastener welding apparatus of claim 3 wherein the internal volume is of a size such that changes in the volume within the housing due to actuation of the welding tool have a negligible effect on the motion of the welding tool.

5. The underwater fastener welding apparatus of claim 1 including a hose coupled to the inlet and the pressurized gas.

6. The underwater fastener welding apparatus of claim 1 including a pressure relief device connected to the housing.

7. The underwater fastener welding apparatus of claim 1 including a flexible front seal assembly attached to the housing allowing movement of the welding tool during a welding operation and changes to the displacement or volume of the housing.

8. The underwater fastener welding apparatus of claim 7 including a rear seal assembly attached to the housing allowing access to the inside of the housing.

9. The underwater fastener welding apparatus of claim 8 wherein the front and rear seal assemblies include seal plates positioned about open ends of the housing, the seal plates receiving seals that are positioned in seal seats formed on the housing.

10. The underwater fastener welding apparatus of claim 9 wherein the front and rear seal plates are joined by tie rods that tighten to seal the front and rear seal assemblies relative to the housing.

11. The underwater fastener welding apparatus of claim 1 including handles attached to the housing for manipulating the underwater welding apparatus.

12. The underwater fastener welding apparatus of claim 1 including a foot assembly attached to the housing.

13. The underwater fastener welding apparatus of claim 12 wherein the foot assembly includes a foot plate attached to legs, the legs adjustably attached to the housing.

14. The underwater fastener welding apparatus of claim 13 wherein the foot assembly includes magnets mounted thereon.

15. The underwater fastener welding apparatus of claim 14 wherein at least one of the magnets is fixed relative to a foot plate and another magnet or magnets are adjustable relative to the foot plate.

16. The underwater fastener welding apparatus of claim 15 wherein the adjustable magnet or magnets are attached to a shaft that is biased by a spring or springs relative to the foot plate accommodating welding to surfaces that are not level.

17. The underwater fastener welding apparatus of claim 1 including a welding tool lead penetrating and sealed relative to the housing, the weld tool lead coupled to the welding tool.

18. The underwater fastener welding apparatus of claim 1 including a welding cable attached to the welding tool.

19. The underwater fastener welding apparatus of claim 1 including a chuck assembly attached to the welding tool, the chuck assembly designed to hold a part to be welded.

20. The underwater fastener welding apparatus of claim 1 including a ferrule attached to the welding tool about a part to be welded.

21. The underwater fastener welding apparatus of claim 20 wherein the ferrule includes a waterproof coating applied thereon.

22. The underwater fastener welding apparatus of claim 20 wherein the ferrule is formed of a ceramic material impermeable to water.

23. The underwater fastener welding apparatus of claim 1 wherein the welding tool is selected from drawn arc and CD welding tools.

24. An underwater fastener welding apparatus comprising:
a welding tool positioned within a watertight housing, the housing including an inlet coupled to a source of pressurized gas;
wherein the housing is pressurized to balance a pressure internal to and external to the housing, and wherein a weld is performed in a wet environment.
